(19) United States
(12) Patent Application Publication
(10) Pub. No.: US 2016/0343486 A1
(43) Pub. Date: Nov. 24, 2016

(54) COIL ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: You Na KIM, Suwon-si (KR); Moon Soo PARK, Suwon-si (KR); Dong Hwan LEE, Suwon-si (KR); Hye Yeon CHA, Suwon-si (KR); Jong Ho LEE, Suwon-si (KR)

(21) Appl. No.: 14/995,986

(22) Filed: Jan. 14, 2016

(30) Foreign Application Priority Data
May 19, 2015 (KR) 10-2015-0069722

(51) Int. Cl. H01F 1/24; H01F 41/02; H01F 41/04

(52) U.S. Cl. CPC H01F 1/24; H01F 41/04; H01F 41/0246

(57) ABSTRACT

A coil electronic component is provided that includes a magnetic body including a core part and a coil wound around the core part. The core part includes metal flakes and a resin, and is formed by injection-molding. Methods of manufacturing the coil electronic component are provided. The methods include injection-molding metal flakes and a resin to prepare a cylindrical structure around which the coil is provided.

### CROSS-REFERENCE TO RELATED APPLICATION

This application claims the priority and benefit of Korean Patent Application No. 10-2015-0069722 filed on May 19, 2015, with the Korean Intellectual Property Office, the disclosure of which is incorporated herein by reference.

### BACKGROUND

The present disclosure relates to a coil electronic component and a method of manufacturing the same.

An inductor, a coil electronic component, is a representative passive element used in electronic circuits together with a resistor and a capacitor to remove noise.

An inductor may be manufactured by forming a coil, hardening a magnetic powder-resin composite in which magnetic powder and a resin are mixed with each other to manufacture a magnetic body enclosing the coil, and forming external electrodes on outer surfaces of the magnetic body.

As part of manufacturing an inductor according to the related art, end portions of the coil may be outwardly exposed using a mold and the exposed end portions of the coil and the external electrodes may be connected to each other.

However, the method of manufacturing an inductor described above may disadvantageously increase packing factors of a magnetic material enclosing the coil and a magnetic material provided in a core part in the coil.

### SUMMARY

An aspect of the present disclosure may provide a coil electronic component in which a packing factor of a magnetic material may be significantly increased and high magnetic permeability may be implemented.

According to an aspect of the present disclosure, a coil electronic component includes a magnetic body including a core part and a coil wound around the core part. The core part includes metal flakes and a resin, and is formed by injection-molding.

According to another aspect of the present disclosure, a method of manufacturing a coil electronic component includes injection-molding metal flakes and a resin to prepare a cylindrical structure. Core parts cut from the cylindrical structure are loaded on a substrate, and coils are loaded onto the core parts. The core parts onto which the coils are loaded are enclosed with a magnetic body containing metal powder.

According to another aspect of the present disclosure, a method of manufacturing a coil electronic component includes injection-molding metal flakes and a resin to prepare a cylindrical structure. Coils are inserted onto the cylindrical structure, and core parts cut from the cylindrical structure onto which the coils are inserted are loaded on a substrate. The core parts around which the coils are wound are then enclosed with a magnetic body containing metal powder.

According to a further aspect of the present disclosure, a method of making a coil electronic component includes forming a core part including metal flakes and a resin by injection molding, disposing a coil around the core part, and forming a magnetic body including a metal powder and enclosing the core part having the coil disposed around the core part.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view illustrating a coil electronic component according to an exemplary embodiment in the present disclosure;

FIG. 2 is a cross-sectional view taken along line I-I′ of FIG. 1;

FIGS. 3A through 3D are views illustrating sequential steps of a method of manufacturing a coil electronic component according to an exemplary embodiment; and

FIGS. 4A through 4D are views illustrating sequential steps of a method of manufacturing a coil electronic component according to another exemplary embodiment.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided for illustrative purposes so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Coil Electronic Component

Hereinafter, a coil electronic component according to an exemplary embodiment, particularly, a power inductor, will be described. However, the coil electronic component according to an exemplary embodiment is not limited thereto.

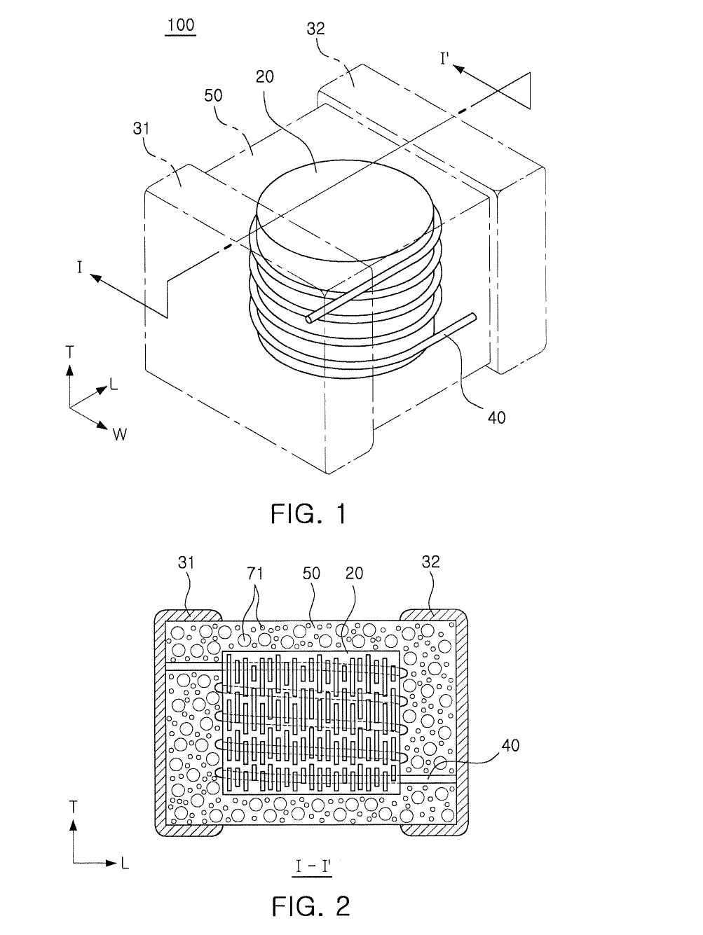

FIG. 1 is a perspective view illustrating a coil electronic component according to an exemplary embodiment. Portions of the coil electronic component are shown as being translucent for illustrative purposes so that a coil of the coil electronic component is visible.

Referring to FIG. 1, a power inductor used in a power line of a power supplying circuit is disclosed as an example of the coil electronic component.

A coil electronic component 100 according to an exemplary embodiment may include a magnetic body 50 including a core part 20 and a coil 40 wound around the core part 20, and first and second external electrodes 31 and 32 disposed on outer surfaces of the magnetic body 50 and contacting respective opposing ends of the coil 40.

In the coil electronic component 100 according to an exemplary embodiment, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The coil 40 may be fitted onto the core part 20 by winding the coil 40 around or on the core part 20, but the disclosure is not limited thereto.

For example, the coil 40 may be wound by rectangular copper wire heat fusion, and a form of the wound coil 40 may be maintained by shape forming.

The coil 40 may have a solenoid shape.

The coil 40 may be formed of a metal having excellent electrical conductivity, such as silver (Ag), palladium (Pd), aluminum (Al), nickel (Ni), titanium (Ti), gold (Au), copper (Cu), platinum (Pt), or alloys thereof.

The coil 40 may be coated with an insulating film (not illustrated), and thus the coil 40 may not directly contact (and may be electrically insulated from) a magnetic material forming the magnetic body 50.

The magnetic body 50 enclosing the coil 40 may contain or be formed of a magnetic material that exhibits magnetic properties. For example, the magnetic body 50 may contain ferrite or a metal magnetic powder.

The higher the magnetic permeability of the magnetic material contained in the magnetic body 50, and the larger the area of the magnetic body 50 through which a magnetic flux passes, the higher the inductance (L) of the coil electronic component 100.

One end portion of the coil 40 may extend so as to be exposed to one end surface of the magnetic body 50 in the length direction, and the other end portion of the coil 40 may extend so as to be exposed to the other end surface (e.g., an opposing end surface) of the magnetic body 50 in the length direction.

However, the coil 40 is not limited thereto, and may more generally be exposed to at least one surface of the magnetic body 50.

The first and second external electrodes 31 and 32 may be formed on the outer surfaces of the magnetic body 50 so as to be electrically connected, respectively, to opposing ends of the coil 40 that are exposed to the end surfaces of the magnetic body 50 in the length direction.

The first and second external electrodes 31 and 32 may be formed of a metal having excellent electrical conductivity, such as copper (Cu), silver (Ag), nickel (Ni), tin (Sn), or alloys thereof.

FIG. 2 is a cross-sectional view taken along line I-I′ of FIG. 1.

Referring to FIG. 2, the core part 20 may be formed of and include metal flakes and a resin, and may be formed by injection-molding. In the illustration of FIG. 2, the metal flakes are illustratively shown as rectangles within the core part 20; the resin fills gaps between the metal flakes in the core part 20.

In general, the metal flakes are formed of or include a magnetic material. In such examples, since the core part 20 is filled with a magnetic material, the magnetic flux passing through the cross-sectional area of the magnetic body may be increased and the inductance (L) of the coil electronic component 100 may be increased.

Furthermore, in the coil electronic component 100, a packing factor of the magnetic material filled in (or forming) the core part 20 may have a correlation to the inductance (L) of the coil electronic component 100.

In earlier methods of manufacturing inductors, there was a limitation in increasing a packing factor of any magnetic material forming the core part in a coil and enclosing the coil, and thus there was a limitation in increasing inductance of the coil electronic component.

In contrast, in the exemplary embodiment presented herein, the core part 20 may include metal flakes and a resin, and may be formed by injection-molding. The use of injection-molding to form the core part allows for a packing factor of the magnetic material in the core part 20 to be significantly increased. In some examples, the packing factor of the magnetic material in the core part 20 may exceed a packing factor of a material forming the magnetic body 50.

To form the core part 20, metal flakes, which are formed of a material having a high magnetic permeability, and a crystalline epoxy resin may be injected into an injection molding machine and then be injection-molded to manufacture a cylindrical structure.

Next, the cylindrical structure may be cut in accordance with a size of the core part of the coil electronic component, and thus the core part 20 in which the packing factor of the magnetic material is significantly increased may be formed.

The packing factor of the magnetic material in the core part 20 formed by injection-molding is very high, notably as compared to examples in which a coil is embedded into a mold into which slurry containing a magnetic material is injected and the slurry is subjected to room temperature compression. Specifically, by using high temperature compression and the like, the packing factor of the magnetic material in the core part 20 formed by injection-molding can be increased, and a high inductance can thus be provided for the coil electronic component 100.

Meanwhile, the core part 20 may be formed of or otherwise include metal flakes and resin.

The resin is not particularly limited, but may be, for example, a crystalline epoxy resin or another appropriate type of resin.

The metal flakes, which are formed of a material having high magnetic permeability, may be formed of a metal powder exhibiting shape anisotropy (referenced herein as a shape anisotropy metal powder). For example, the metal powder may exhibit magnetic anisotropy, and/or particles of the metal powder may be non-spherical and may exhibit a stronger magnetic permeability in one direction as compared to another direction.

The metal flakes formed of the shape anisotropy metal powder may contain one or more metals selected from the group consisting of iron (Fe), silicon (Si), boron (B), chrome (Cr), aluminum (Al), copper (Cu), niobium (Nb), and nickel (Ni), or alloys thereof, and may be formed of a crystalline or amorphous metal.

For example, the metal flake including the shape anisotropy metal powder may be formed of a Fe—Si—Cr based amorphous metal, but is not limited thereto.

The metal flakes including the shape anisotropy metal powder may be included in the core part 20 so as to be dispersed in a thermosetting resin.

The thermosetting resin may be, for example, an epoxy resin, a polyimide resin, or the like, and may be, particularly, a crystalline epoxy resin.

Features of the shape anisotropy metal powder and of a shape isotropy metal powder will be described in detail below.

A shape isotropy metal powder may be formed of powder particles having a spherical shape. Shape isotropy means that the same property (e.g., shape-related property, or magnetic permeability) is shown in all of x, y, and z axis directions. As such, particles of the shape isotropy metal powder have the same property regardless of the direction/orientation/rotation along which the property is measured.

For example, a particle of a shape isotropy metal powder may show the same magnetic permeability along each of the x, y, and z axes of the particle.

In contrast, the metal flakes formed of the shape anisotropy metal powder may have properties different from each other in the x, y, and z axis directions. For example, magnetic permeability may be higher in one direction (e.g., an x direction) than in another (e.g., a z direction).

An example of a shape anisotropy metal powder may include a flake-shaped metal powder, that is, a metal flake, and the like.

Generally, a shape anisotropy metal powder may have a magnetic permeability that is higher than that of a shape isotropy metal powder. Therefore, to provide higher magnetic permeability to the coil electronic component 100, the component is preferably manufactured using sheets containing the shape anisotropy metal powder having a magnetic permeability higher than that of a shape isotropy metal powder, in order to improve inductance (L) of the coil electronic component 100.

However, since the magnetic permeability of the shape anisotropy metal powder can change in different directions, the magnetic permeability of the shape anisotropy metal powder may be higher than that of the shape isotropy metal powder in one direction (e.g., along an x axis direction) but may be lower than that of the shape isotropy metal powder in another direction (e.g., along a z axis direction). For example, the magnetic permeability of the shape anisotropy metal powder may be very low in a specific direction (e.g., along the z axis direction) and may thereby impede a flow in the specific direction of a magnetic flux generated by a current applied to the coil.

For example, when using the metal flakes formed of the shape anisotropy metal powder, the metal flakes have flattened shapes extending along x and y axis directions and having thin cross-sections along the z axis direction (e.g., the cross-section of the flakes along the z-axis may be substantially less than the cross-sections of the flakes along either of the x or y axes). In such metal flakes, magnetic permeability in the x and y axis directions on flake-shaped surfaces may be high, but magnetic permeability in the z axis direction perpendicular to the flake-shaped surfaces may be very low. Therefore, the metal flakes formed of the shape anisotropy metal powder as described above may impede a flow of the magnetic flux flowing in the z axis direction, and thus inductance L may be decreased.

In an exemplary embodiment, as illustrated in FIG. 2, the metal flakes having the form of the shape anisotropy metal powder may be arranged so that one axis of the flake-shaped surfaces (e.g., the x-axis) is parallel with a direction in which the magnetic flux flows (e.g., a vertical direction ‘T’ in the figure, such as a to direction aligned with a main axis of the coil). The metal flakes may be arranged to that an axis orthogonal to the flake-shaped surface (e.g., the z axis) is orthogonal to the direction in which the magnetic flux flows through the coil.

That is, in a case in which the metal flakes are arranged so that one axis of the flake-shaped surfaces is parallel with the direction in which the magnetic flux flows, as described above, the metal flakes may be disposed parallel with a direction in which the coil is wound.

In addition, the metal flakes may be disposed so that one axis of the flake-shaped surfaces of the shape anisotropy metal powder is parallel with the direction of the magnetic flux (e.g., a direction of the magnetic flux produced by the coil 40).

Therefore, a direction of higher magnetic permeability of the metal flakes may be adjusted to coincide with the direction of the magnetic flux.

Since the metal flakes formed of the shape anisotropy metal powder show high magnetic permeability in one axis direction of the flake-shaped surfaces, the metal flakes may be arranged so that the one axis of the flake-shaped surfaces thereof is parallel with the direction in which the magnetic flux flows, thereby smoothing the flow of the magnetic flux and improving inductance (L) of the coil electronic component 100 through high magnetic permeability. In addition, an excellent quality (Q) factor, excellent direct current (DC) bias characteristics, and the like, may be implemented through a high saturation magnetization value (Ms) of the shape anisotropy metal powder.

A method of arranging the metal flakes during manufacture of the core part 20 so that one axis of the flake-shaped surfaces thereof is parallel with the direction in which the magnetic flux flows as described above may be implemented by forming the core part 20 by injection-molding.

Meanwhile, in the coil electronic component 100 according to an exemplary embodiment illustrated in FIG. 2, a magnetic material filled region (e.g., shown at 50) enclosing the core part 20 and the coil wound around the core part may include shape isotropy metal powder 71. However, the magnetic material filled region is not limited thereto, and may be filled with shape anisotropy powder oriented in accordance with the flow of the magnetic flux.

According to an exemplary embodiment, the core part 20 may include the metal flakes and the resin, and may be formed by injection-molding, and thus a packing factor of the magnetic material in the inductor may be significantly increased, and the direction of the magnetic flux and the direction of the magnetic permeability of the shape anisotropy metal powder may coincide with each other, whereby high magnetic permeability may be implemented.

Method of Manufacturing Coil Electronic Component

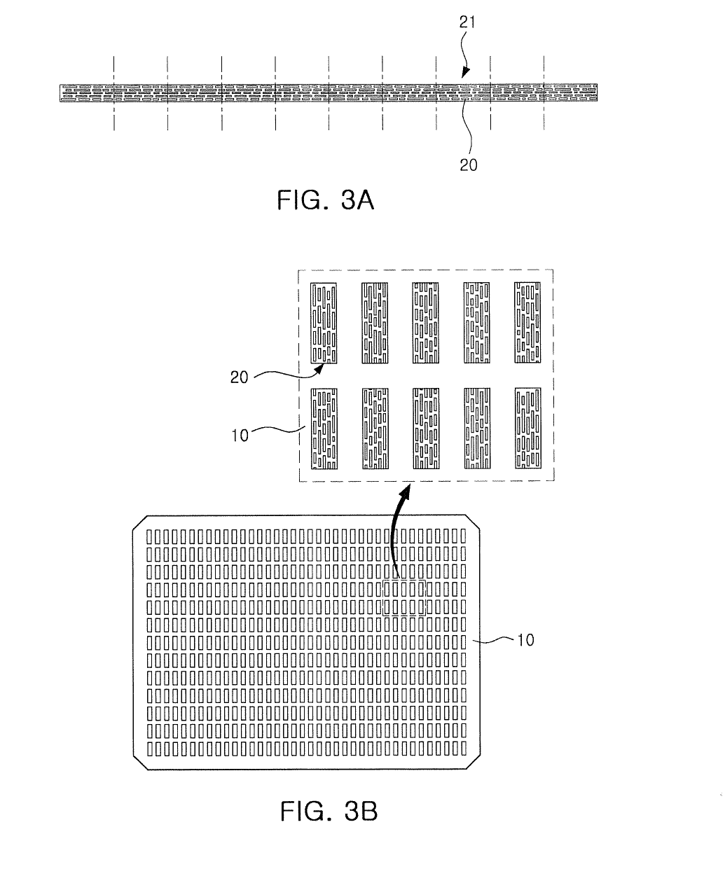

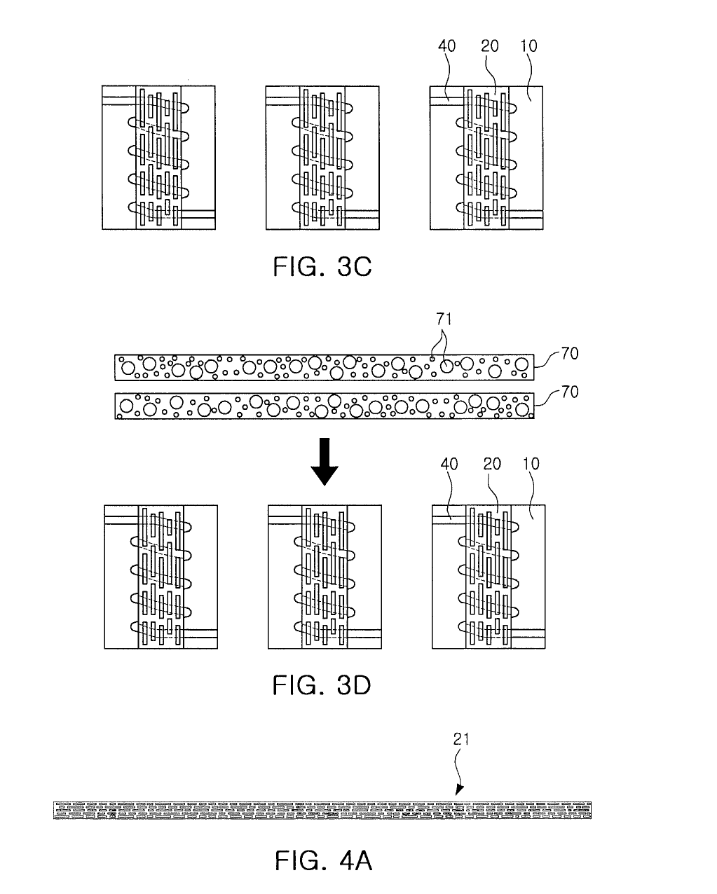

FIGS. 3A through 3D are views illustrating sequential steps of a method of manufacturing a coil electronic component according to an exemplary embodiment.

A method of manufacturing a coil electronic component according to an exemplary embodiment may include injection-molding the metal flakes and the resin to prepare the cylindrical structure, loading the core parts cut from the cylindrical structure on a substrate, loading the coils onto the core parts, and enclosing the core parts onto which the coils are loaded with the magnetic body containing the metal powder.

Referring to FIG. 3A, first, the metal flake material, which is the high magnetic permeability material, and the crystalline epoxy resin may be injected into an injection molding machine and then be injection-molded to prepare the cylindrical structure 21.

Next, the cylindrical structure 21 may be cut in accordance with a size of the core part of the coil electronic component, and thus a plurality of core parts (including the core part 20) may be formed in which the packing factor of the magnetic material is significantly increased.

Referring to FIG. 3B, the core parts 20 cut from the cylindrical structure 21 may be loaded on the substrate 10.

As the substrate 10, a polypropylene glycol (PPG) substrate, a ferrite substrate, a metal based soft magnetic substrate, or the like, may be used.

Referring to FIG. 3C, the coils 40 may be loaded onto or around the core parts 20 that were loaded on the substrate 10.

Each coil 40 may be formed of a conductive metal having excellent electrical conductivity, such as silver (Ag), palladium (Pd), aluminum (Al), nickel (Ni), titanium (Ti), gold (Au), copper (Cu), platinum (Pt), or an alloys thereof.

The coils 40 may be loaded by winding the coils 40 by rectangular copper wire heat fusion, forming the coils 40 in solenoid shapes, and then inserting the coils 40 onto the core parts 20 loaded on the substrate 10, but are not limited thereto.

Referring to FIG. 3D, sheets 70 containing the shape isotropy metal powder 71 may be disposed on one surface and the other surface of the substrate in order to fill the magnetic material in the vicinity of the core parts 20 loaded on the substrate 10 and the coils 40 wound around the core parts 20, and may be stacked, compressed, and hardened to form the magnetic bodies 50 enclosing the core parts 20 and the coils 40.

The sheets 70 may be manufactured in a sheet shape by mixing the shape isotropy metal powders 71, a thermosetting resin, and organic materials such as a binder, a solvent, and the like, with each other to prepare a slurry and applying and then drying the slurry on carrier films by a doctor blade method.

The sheet 70 may be manufactured in a form in which the shape isotropy metal powder 71 is dispersed in a thermosetting resin such as an epoxy resin, a polyimide resin, or the like.

Next, the first and second external electrodes 31 and 32 may be formed on the outer surfaces of the magnetic body 50 so as to be connected to the coil 40.

A description for features overlapping those of the coil electronic component according to the exemplary embodiment described above except for the above-mentioned description will be omitted.

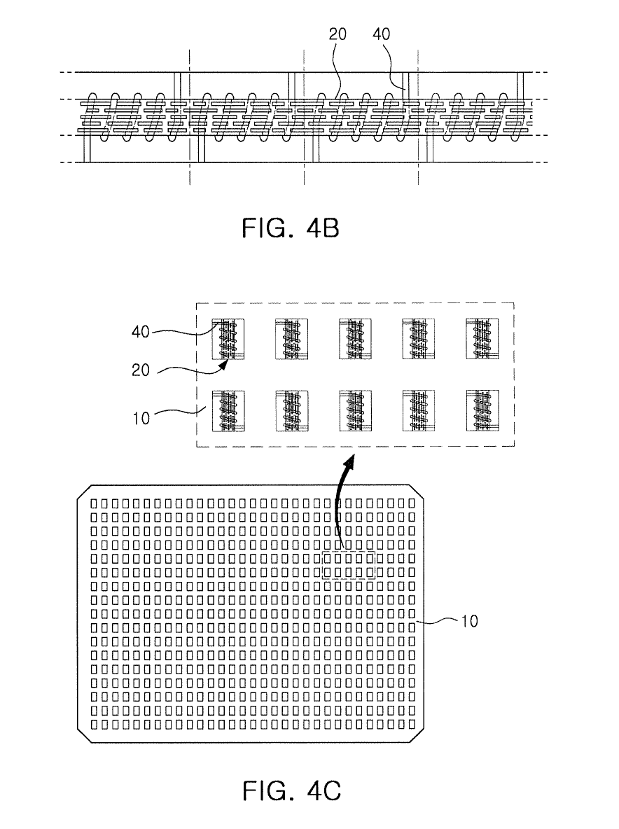

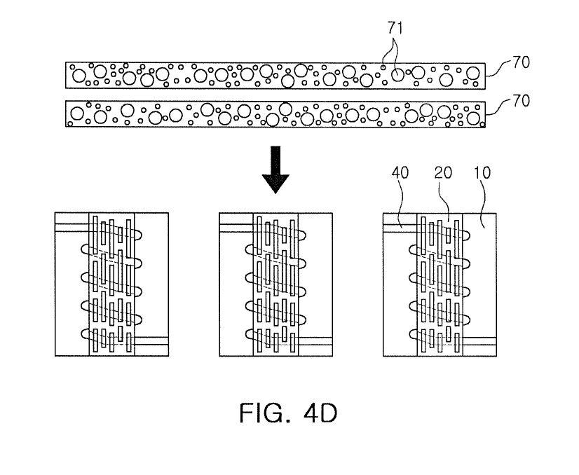

FIGS. 4A through 4D are views for describing sequential steps of a different method of manufacturing a coil electronic component according to another exemplary embodiment.

A method of manufacturing a coil electronic component according to another exemplary embodiment may include injection-molding the metal flakes and the resin to prepare the cylindrical structure, inserting the coils onto the cylindrical structure, loading the core parts cut from the cylindrical structure onto which the coils are inserted on a substrate, and enclosing the core parts around which the coils are wound with the magnetic body containing the metal powder.

Referring to FIG. 4A, first, the metal flake material, which is the high magnetic permeability material, and the crystalline epoxy resin may be injected into an injection molding machine and then be injection-molded to prepare the cylindrical structure 21.

Referring to FIG. 4B, the coils 40 formed in advance in accordance with a size of the coil electronic component may be loaded around the cylindrical structure 21.

Next, the cylindrical structure 21 around which the coils 40 are loaded may be cut in accordance with a size of the core part to of the coil electronic component, and thus the core part 20 in which the packing factor of the magnetic material is significantly increased may be formed.

Referring to FIG. 4C, the core parts 20 onto which the coils 40 are loaded may be loaded on the substrate 10.

Referring to FIG. 4D, sheets 70 containing the shape isotropy metal powder 71 may be disposed on one surface and the other surface of the substrate in order to fill the magnetic material in the vicinity of the core parts 20 loaded on the substrate and the coils 40 wound around the core parts 20, and may be stacked, compressed, and hardened to form the magnetic body 50 enclosing the core parts 20 and the coils 40.

A description of features overlapping those of the method of manufacturing coil electronic component according to another exemplary embodiment described above except for the above-mentioned description will be omitted.

As set forth above, according to exemplary embodiments, the packing factor of the magnetic material in the inductor may be significantly increased, and the direction of the magnetic flux and the direction of the magnetic permeability of the shape anisotropy metal powder may coincide with each other, and thus high magnetic permeability may be implemented.

While exemplary embodiments have been shown and described above, it will be apparent to those skilled in the art that modifications and variations could be made without departing from the scope of the present invention as defined by the appended claims.

What is claimed is:

1. A coil electronic component comprising:
a magnetic body including a core part and a coil wound around the core part,
wherein the core part includes metal flakes and a resin.

2. The coil electronic component of claim 1, wherein the metal flakes have flattened shapes and are disposed such that an axis orthogonal to a thin cross-section of the metal flake is parallel with a direction in which the coil is wound.

3. The coil electronic component of claim 1, wherein the metal flakes include a shape anisotropy metal powder.

4. The coil electronic component of claim 3, wherein the metal flakes are disposed such that one axis along a flake-shaped surface of each metal flake is parallel with a direction of a magnetic flux of the coil.

5. The coil electronic component of claim 1, wherein a direction of maximum magnetic permeability of the metal flakes coincides with a direction of a magnetic flux of the coil.

6. The coil electronic component of claim 1, wherein the resin is a crystalline epoxy resin.

7. The coil electronic component of claim 1, wherein the metal flakes are formed of a metal containing one or more selected from the group consisting of iron (Fe), silicon (Si), boron (B), chrome (Cr), aluminum (Al), copper (Cu), niobium (Nb), and nickel (Ni), or alloys thereof.

8. The coil electronic component of claim 1, wherein the magnetic body has a first packing factor lower than a second packing factor of the core part.

9. The coil electronic component of claim 1, wherein the metal flakes are oriented substantially parallel to each other in the core part.

10. The coil electronic component of claim 1, wherein the metal flakes of the core part include a shape anisotropy metal powder, and the magnetic body includes a shape isotropy metal powder.

11. A method of manufacturing a coil electronic component, comprising:
injection-molding metal flakes and a resin to prepare a cylindrical structure;
loading core parts cut from the cylindrical structure on a substrate;
loading coils onto the core parts; and
enclosing the core parts onto which the coils are loaded with a magnetic body containing metal powder.

12. The method of claim 11, wherein the coil is a solenoid type coil.

13. The method of claim 11, wherein the step of injection-molding the metal flakes and the resin comprises injection-molding the metal flakes such that each metal flake is disposed with an axis orthogonal to a thin cross-section of the metal flake that is parallel with a direction in which the coil is wound.

14. The method of claim 11, wherein the metal flakes include a shape anisotropy metal powder.

15. The method of claim 14, wherein the metal flakes are disposed in each respective core part such that one axis along a flake-shaped surface of each metal flake is parallel with a direction of a magnetic flux of the coil loaded onto the respective core part.

16. The method of claim 11, wherein a direction of maximum magnetic permeability of the metal flakes coincides with a direction of a magnetic flux of the coil.

17. A method comprising:
forming a core part including metal flakes and a resin by injection molding;
disposing a coil around the core part; and
forming a magnetic body including a metal powder and enclosing the core part having the coil disposed around the core part.

18. The method claim 17, wherein the forming the core part comprises:
forming a cylindrical structure including the metal flakes and the resin by injection molding; and
cutting the cylindrical structure into a plurality of core parts,
wherein the coil is disposed around a core part of the plurality of core parts cut from the cylindrical structure.

19. The method claim 17,
wherein the forming the core part comprises forming a cylindrical structure including the metal flakes and the resin by injection molding,
wherein the disposing the coil around the core part comprises disposing the coil around the cylindrical structure,
wherein the method further includes cutting the cylindrical structure having the coil disposed around the core part into a plurality of core parts, and
wherein the forming the magnetic body comprises forming the magnetic body to enclose a core part of the plurality of core parts having the coil disposed around the core part.

20. The method of claim 17, wherein the forming the core part comprises forming the core part to have a first packing factor using injection molding, and the forming the magnetic body comprises forming the magnetic body to have a second packing factor lower than the first packing factor of the core part.
